(19) United States
(12) Patent Application Publication
(10) Pub. No.: US 2024/0213532 A1
(43) Pub. Date: Jun. 27, 2024

(54) SEMISOLID ELECTROLYTE MEMBRANE AND METHOD OF FABRICATION THEREOF

(71) Applicant: Soelect Inc., Greensboro, NC (US)

(72) Inventor: Sungjin Cho, Summerfield, NC (US)

(21) Appl. No.: 18/571,869

(22) PCT Filed: Mar. 17, 2022
(86) PCT No.: PCT/US2022/020836

§ 371 Date: Dec. 19, 2023

Related U.S. Application Data
(60) Provisional application No. 63/163,445, filed on Mar. 19, 2021.

(51) Int. Cl. H01M 10/0565; H01M 10/0525

(52) U.S. Cl. CPC H01M 10/0565; H01M 10/0525; H01M 2300/0082; H01M 2300/0085; H01M 2300/0094

(57) ABSTRACT

Disclosed herein is a unique semisolid electrolyte structure for utilization within energy storage devices (batteries, capacitors, and the like). Such a semisolid exhibits, simultaneously, flexibility and electrolyte transfer capabilities, thereby allowing for the potential, at least, for such a semisolid article to function as both a battery (or like device) separator and electrolyte supply. Such characteristics and capabilities are imparted through the initial provision of a base substrate that exhibits swelling upon contact with a viscous polymer electrolyte solution, thereby allowing for a first electrolyte to deposit therein opened pores within the swollen base. A second treatment with solid electrolyte may then fill any further open pores therein, allowing for a complete separator/electrolyte article that removes the requirement for liquid, flammable electrolytes, thereby providing a safer device. The manufacturing method is relatively simple and encompassed herein as well.

### CROSS-REFERENCE TO RELATED APPLICATION

This application claims priority to U.S. Provisional Patent Application No. 63/163,445, filed on Mar. 19, 2021. The entirety of this parent provisional application is incorporated herein by reference.

### FIELD OF THE DISCLOSURE

Disclosed herein is a unique semisolid electrolyte structure for utilization within energy storage devices (batteries, capacitors, and the like). Such a semisolid exhibits, simultaneously, flexibility and electrolyte transfer capabilities, thereby allowing for the potential, at least, to function as both a battery (or like device) separator and solid electrolyte supply. Such characteristics and capabilities are imparted through the initial provision of a base substrate that exhibits swelling upon contact with a viscous polymer electrolyte solution, thereby allowing for a first electrolyte to deposit therein opened pores within the swollen base. A second treatment with solid electrolyte may then fill any further open pores therein, allowing for a complete separator/electrolyte article that removes the requirement for liquid, flammable electrolytes, thereby providing a safer device. The manufacturing method is relatively straightforward and encompassed herein as well.

### BACKGROUND OF THE PRIOR ART

Currently, rechargeable energy storage devices, such as lithium-ion batteries, as one example, and particularly those including liquid electrolytes, are widely used and impart the best performance in this commercial area. Such liquid electrolyte systems require certain components that allow for immersion in the liquid electrolyte, allowing for very high conductivity for the transport of lithium ions between the cathode and anode during charge and discharge. These types of batteries include porous structures, particularly a separator, composite cathode, and anode, to allow for liquid electrolyte absorption as it fills the battery chamber. This, in turn, allows for surface contact with the lithium active materials and transport of lithium ions throughout the cell with minimal impedance.

The liquid electrolyte itself consists of a Li salt (for example. LiPF₆) in a solvent blend which typically includes ethylene carbonate and other linear carbonates, such as dimethyl carbonate. Despite improvements in energy density and cycle life, there remain several underlying problems with batteries that contain liquid electrolytes. For example, liquid electrolytes are generally volatile and subject to pressure build up, explosion, and fire under a high charge rate, a high discharge rate, and/or internal short circuit conditions. Additionally, charging at a high rate can cause dendritic lithium growth on the surface of the anode. The resulting dendrites can extend through the separator and internally short circuit in the cell. Further, the self-discharge and efficiency of the cell is limited by side reactions and corrosion of the cathode by the liquid electrolyte. Still further, the liquid electrolyte also creates a hazard if the cell over-heats due to overvoltage or short circuit conditions, creating another potential fire or explosion hazard.

To address safety and reliability problems with such rechargeable energy storage devices, including, again, non-limiting lithium-based batteries, particularly those that employ liquid electrolytes, solid-state batteries that employ high-capacity lithium intercalation compounds are being developed, specifically to also generate and achieve high energy density. To accomplish such a result, however, there are needed solid-state batteries including solid-state electrolyte films that exhibit sufficient and effective charge capabilities with concomitant safety levels. In this manner, solid state electrolyte films are considered those that are static in position within a subject rechargeable energy storage device and that function properly without the need of liquid electrolytes present.

Solid-state batteries have garnered significant attention due to certain attractive performance characteristics, including long shelf life, long-term stable power capability, broad operating temperature ranges, and high volumetric energy density. Such batteries are particularly suited for applications requiring long life under low-drain or open-circuit conditions.

Solid polymer electrolytes (SPE) are attractive, certainly, within such solid-state battery technologies, in part due to advantageous processability, effective electrode contact properties, cost effectiveness, and design flexibility due to the elimination of polymer separators, even if such solid materials exhibit certain deficiencies, such as low ionic conductivity, low thermal stability, and low mechanical strength.

In that manner, then, in order for rechargeable energy storage devices (batteries, again) to be applied not only to electric vehicles, but also to special industries such as aviation, space, defense, and medicine, it is necessary to secure a much higher level of reliability and stability. When a solid-state electrolyte is utilized, such a structural component may solve safety issues such as leakage of and explosion due to liquid electrolytes. Additionally, energy density can be increased due to the simplification of existing battery safety components, as well. However, such a solid electrolyte generally exhibits lower battery power properties due to lower ionic conductivity (as compared with liquid electrolytes) and further exhibits a noticeable higher resistance at the interface between such a solid electrolyte and positive and negative electrodes. The operating principle of all-solid-state batteries and existing lithium secondary batteries is the same fundamentally, but the risk of fire and explosion due to temperature changes and external shocks is reduced by replacing a liquid electrolyte with one that is completely solid. Various solid electrolytes have been developed and utilized in the past, including sulfide-based and oxide-based conductive polymers with performance levels that need improvement, particularly in terms of increased ionic conductivity and lower interface resistance between the positive and negative electrodes and such prior solid electrolyte materials.

In addition to the potential deficiencies of solid-state electrolytes noted above, such high solid (above 250 MPa strength, for instance) electrolyte articles may present other types of problems, particularly due to the rigidity thereof and thus the potential for damage internally if external forces are applied, whether accidentally or not, to the overall electrical device. This rigidity level is thus potentially detrimental since any loss in structural stability of the solid electrolyte article may lead to losses of energy density and reduced charge/discharge rates, at least. There is thus a benefit to reducing if not eliminating the utilization of liquid electrolytes within such rechargeable energy storage devices, but the reliance on highly rigid solid electrolytes may impart other difficulties under certain conditions. However, even with the ability to remove the need for polymer separators from rechargeable devices, the completely rigid solid electrolyte may be limited in effectiveness overall.

Thus, there is a need to develop solid-type electrolyte articles that do not exhibit the undesirable characteristics of damage susceptibility and propensity noted in relation to highly rigid (above about 75 MPa, certainly at the typical 250 MPa strength levels noted above) solid-state electrolyte articles. The ability, then, to accord a solid-like electrolyte article that exhibits reduced likelihood of breakage due to external force application, and thus is flexible in nature when utilized as a solid-like article, and further reduces or eliminates the need for liquid electrolyte for recharging functionality, would be quite prized in this industry. To date, there has been lacking such a solution. The present disclosure addresses such issues and present a solution to this obstacle to solid-state implementation within the recharge energy storage device area.

### ADVANTAGES AND SUMMARY OF THE DISCLOSURE

A distinct advantage of this disclosure is the simultaneous capability of a semisolid electrolyte article to act as a suitable separator and electrolyte conduit within a rechargeable energy storage device. Another distinct advantage is the ability of the semisolid electrolyte article to exhibit flexibility and low rigidity subsequent to electrolyte introduction. Thus, another distinct advantage of the disclosure is the versatility of the semisolid electrolyte article to allow sufficient electrolyte transfer for safe and effective charge/discharge cycles and efficiency thereof during such cycles for long-term utilization of a subject energy storage device therewith. Yet another advantage of this disclosure is the low cost of manufacture with prevalent base materials and unexpectedly effective method steps that utilize the structural aspects of such base materials to great benefit.

Accordingly, this disclosure encompasses a semisolid electrolyte membrane exhibiting a tensile strength of from 1 to 50 MPa, wherein said membrane comprises a swollen porous base material having a top side and a bottom side and selected from hydrophilic fibers, hydrophilic films, and any combinations thereof, wherein said swollen porous base material comprises at least two layers of electrolyte deposited thereon at least one of said top and bottom side thereof, wherein a first layer of said electrolyte deposition resides within at least some of the pores as well as on the surface of said swollen porous base material and wherein a second layer of said electrolyte deposition resides on top of said first layer of said electrolyte deposition, and wherein said semisolid electrolyte membrane exhibits ionic conductivity of from 10⁻⁴ S/cm to 10⁻³ S/cm.

For this disclosure, the term “semisolid” is intended to convey a distinction from solid (and thus rigid) solid-state electrolyte structures that have no flexible properties. To the contrary, then, semisolid is intended to encompass a material that exhibits flexibility (with, as noted herein, a tensile strength of from 1 to 50 MPa, for instance) for effective placement between an anode and a cathode within an energy storage device, while also including thereon solid electrolyte deposits for ionic conductivity.

Additionally, the disclosed semisolid electrolyte membrane provided herein may also comprise electrolyte deposition layers that include rotating molecules to permit passing through said membrane for charge and discharge therein. Such rotating molecules may include, within limitation, cyano molecules, such as mono- and di-cyano molecules including, without limitation, 1,4-Dicyanobutane, 1,2-Dicyanoethane, 1,3-Dicyanopropane, 1,5-Dicyanopentane, 1,6-Dicyanohexane, trans-1,4-Dicyano-2-butene, trans-1,2-Dicyanoethylene, α-methyl-valerodinitrile, percyanoethylene, tetracyanoethylene, 2,5-Cyclohexadiene-1,4-diylidene and any like cyano-derivatives thereof. Such a membrane may further comprise at least two distinct electrolyte deposition layers, as defined above, on both the top and bottom side of said base material, effectively providing a flexible base material with such deposited electrolytes in solid form, thereby allowing for a semisolid separator/electrolyte structure. In this manner, the utilization of liquid electrolytes may be eliminated (or at least drastically reduced) since the solid-state electrolyte structure allows for such ion transfer therethrough when utilized in this fashion. Coupled with the flexibility thereof, the overall semisolid porous membrane accords a significantly different separator/electrolyte article than heretofore explored within the rechargeable energy storage device industry.

As it concerns the base material for such a flexibility membrane, particularly effective are highly hydrophilic fibers/films/membranes that exhibit swelling at the surface thereof, at least, upon exposure to, contact with, and other type of application thereto of a viscous polymer formulation (and thus exhibits a swollen structure as a result). In this manner, the base material allows for opening of the surfaces thereof for pore availability and thus electrolyte deposition therein upon such a swelling procedure. Any type of hydrophilic material with such swelling capability is thus possible, including natural, biodegradable polymers, as well as synthetic polymers exhibiting such properties. Potentially preferred, however, are natural polymers (and biodegradable, potentially, as well) including, without limitation, cellulose, hemi-cellulose, lignin, and any combinations thereof. Such a base material allows for separator utilization in this context, and, importantly, permits such electrolyte deposition thereon in two distinct layers for overall effectiveness as it concerns ionic transfer from on outer layer to the other through the base material as well as the resultant flexibility even with such electrolyte deposits present therein and thereon to function as a suitable battery separator. Additionally, the thickness of the base material (and thus the semisolid electrolyte article itself) should be, at maximum, 200 μm with a minimum of 20 μm, roughly.

Of significance in this disclosure, particularly as it concerns such base hydrophilic films and fibers, such standalone base materials are ineffective battery separators. For instance, the consideration of cellulose is counterintuitive for the end use of the disclosed semisolid electrolyte membranes. Cellulose is the most abundant biodegradable and natural polymer present on earth. Mostly, cellulose material exhibits high mechanical strength due to significant hydrogen bonding between its base chemical chains. Additionally, such a material exhibits superior wettability when exposed to liquids. Such wettability, however, creates a deleterious swelling effect if utilized as a stand-alone material as a battery separator. In such battery applications, swelling in the presence and upon exposure and contact with liquid electrolytes reduces certain chemical and physical properties of the base cellulose. Such a chemical affinity issue between liquid electrolyte, particularly those including carbonate solvents, at least, generates sudden and increased swelling within the cellulose base (and surface thereof), which leads to an increase in the free volume within the cellulose by way of pores therein. On its own, such a swollen cellulose appears to capture electrolyte rather than pass it through, thereby “clogging” the cellulose separator and effectively impeding any further sustained ion transfer. Thus, with such a cellulose separator (again, without any electrolyte deposition thereon or therein), any volume change (or mechanical structure change) therein such a membrane directly subsequent to a first battery cycling, the ability to then permit and provide any further battery cycling is unsustainable. Thus, the utilization of a swellable cellulose or like hydrophilic (and potentially preferable) biodegradable material as a battery separator is problematic.

To the contrary, however, as disclosed herein, it has now been realized that the swellable nature of such materials can now be utilized to great beneficial effect. Such an initial and significant disadvantage of cellulose fibers in terms of battery applications on its own has been captured in a different manner since such a swelling effect may be undertaken well prior to introduction and utilization within an energy storage device. It has now been realized that initial cellulose (or like material, basically any hydrophilic fiber, film, or membrane that exhibits swelling upon contact with an electrolyte-containing liquid polymer formulation) swelling may be followed by filling the swelled pores of the base material with a highly ionically conductive polymer solution to fabricate a mechanical robust and electrochemically outperforming polymer solution for two-layer electrolyte deposition to great effect. The controlled ability of depositing ionically conductive materials (such as the cyano, dicyano, dinitrile, and the like electrolyte formulation components noted above) prior to utilization, rather than during cellulose separator utilization on its own, results in a versatile and heretofore unexplored pathway to solid electrolyte articles. With the ionically conductive electrolyte deposits on and within the base material, the ability to permit lithium (or other) ions therethrough provide a separator structure that has never been explored in this industry. The failures of the cellulose and like hydrophilic materials in the past are thus taken advantage of within this disclosure as the semisolid (with low tensile strength) accords the necessary separator property of providing a reliable barrier between a subject anode and cathode and exhibits suitable electrical insulation to prevent short circuiting within a target energy storage device, as well. The further capability of ionic conductivity further permits effective lithium (again, or other) ion transfer for charging/discharging of the target energy storage device during utilization thereof. Thus, the base material must be, in total, such a hydrophilic fiber, film, or membrane to accomplish this result (as well as providing a base material that, on its own, would not be effective as a battery separator in the presence of liquid electrolytes). Such a method/process involves a first step, wherein more than 10% by weight of a electrolyte polymer solution is applied on the base cellulose (or other hydrophilic material, fiber or film), which is then either dried at room temperature or subjected to an elevated temperature under vacuum. This allows for permanent opening of the base material pores such that prior to fully drying of the swollen membrane, a second coating is applied which fills all residual voids after swelling of cellulose membrane. This method thus permits two distinct layers of electrolyte deposition on the base material of the semisolid membrane prior to actual utilization thereof within a subject energy storage device.

Such electrolyte formulations for deposition on the base polymer material (highly hydrophilic fibers/films/membranes like cellulose, lignin or any like natural polymer materials and combinations thereof) including the following:
a. rotating molecules included cyano molecules included mono and dicyano molecules included 1,4-Dicyanobutane, 1,2-Dicyanoethane, 1,3-Dicyanopropane, 1,5-Dicyanopetane, 1,6-Dicyanohexane, trans-1,4-Dicyano-2-butene, trans-1,2-Dicyanoethylene, α-methyl-valerodinitrile, percyanoethylene, Tetracyanoethylene, 2,5-Cyclohexadiene-1,4-diylidene and any cyano-derivatives thereof;
b. polymers, including, without limitation, synthetic polymers such as polyethylene oxide or glycol, polymethyl methacrylate, polyacrylonitrile, polyvinyl alcohol, polyvinylidene fluoride, polyvinylidene difluoride, polytetrafluoroethylene, poly(styrene-co-acrylonitrile), poly(acrylonitrile-co-butadiene-co-styrene), acrylonitrile butadiene rubber (NBR), as well as biopolymers/bioplastics such as collagen, gelatin, starch, cellulose, hemi-cellulose, lignin, alginate, chitosan or any combination of synthetic and synthetic or synthetic and biopolymer(s); and,
c. either or both polarizable and non-polarizable lithium salt(s) included lithium bis(trifluoromethanesulfonyl)imide (LiTFSI), Lithium bis(fluorosulfonyl)imide (LiFSI), lithium hexafluoroarsenate (LiAsF₆), lithium hexafluorophosphate (LiPF₆), lithium tetrafluoroborate (LiBF₄), lithium perchlorate (LiClO₄), lithium bis(oxalato)borate (LiBOB) and lithium (difluorooxalato) borate (LiDFOB) and/or any combinations thereof.

In addition to such electrolyte formulations, the thin porous semisolid polymer electrolyte membrane may further comprise one or more nano and/or micron sized particles as a filler component. Such a filler may be selected from the group of oxide, carbide, nitride, halide based inorganic materials such as Li_{1.3}Al_{0.3}Ti_{1.7}(PO₄)₃, Li_{1.5}Al_{0.5}Ge_{1.5}(PO₄)₃, Li₇La₃Zr₂O₁₂, Li_{0.33}La_{0.557}TiO₃, Li₂O—SiO₂—TiO₂—P₂O₅, Al₂O₃, SiO₂, TiO₂, BaTiO₃, Ta₂O₅, ZrO₂, Si₃N₄, SiC, PbTiO₃, LiNbO₃, AlN (Aluminum Nitride), Y₂O₃, HfO₂, Li₂O, Li₃PO₄, LiNO₃, LiF, LiCl, or/and comprising one or more filler(s) selected from the group of lithiophilic inorganic nano and/or micron sized particles such as Al, Ag, Au, Zn, Mg, Si, Sn, Ge, In, Ba, Bi, B, Ca, Cd, Ir, Pd, Pt, Rh, Sb, Se, Sr, Te, Zn, AgO, MgO, MnO₂, Co₃O₄, SnO₂, SiO₂, SiOx, (0.5<x<1.5), ZnO and its hybrid material included either one from metal or non-metal included clay.

The mixing process utilizing the polymer solution can be modified as needed depending upon the selection of polymer and solvent and their individual or combined physio-chemical properties (particularly as it concerns the ability to swell the base material fibers as described herein).

The present disclosure thus relates to semisolid electrolyte membranes having excellent ionic conductivity, low and flexible mechanical tensile strengths (elasticity), and electrochemical stability. To that end, it was determined that the ionic conductivity and the cycling performance of such a semisolid electrolyte was particularly viable with the presence and utilization of rotating molecules (for example, without limitation, cyano molecules, as noted and described above), combined with a lithium salt(s), and a polymer. A first layer of electrolyte thus is applied as noted above, with a swelling result within the base material. After drying, but with a wet status of the initial electrolyte deposition layer on the base material, a second deposition (casting) is undertaken to provide further pore fill (if any remains) and coating on the surface thereof. Further layering is thus permitted in the same manner (drying to a degree, with a wet surface, then casting another electrolyte layer). Such electrolyte formulations may be applied through coating techniques (knife coating, for instance) and any like applications to a solid base material in this manner. Drying levels may be from 35-100° C., perhaps higher, with times of drying depending on the level desired. With a certain moisture needed on the surface for further electrolyte casting thereon, a high level (100° C.) temperature may only require about 2-5 minutes, whereas a lower temperature would/may require longer times for such a result. The electrolyte formulation themselves may be provided in any amounts in relation to the size of the subject base material. To that end, in manufacture, a large sample of base material may be provided (measured in meters, for instance, in both length and width) and then contacted with the initial polymer electrolyte formulation, dried, and so on. Alternatively, manufacture may be undertaken on individually cut base material structures (centimeters by centimeters, for example) for smaller applications. Such electrolyte polymer formulations may thus be provided from 1 mL increments to liters or higher in volumes, again, dependent on the size of the subject base material.

It should be well understood by the ordinarily skilled artisan in this industry that such a base hydrophilic polymer material may be of any type that provides the aforementioned initial swelling capability therein upon contact with a viscous polymer formulation including electrolytes. Such a material should provide such swelling capability and capacity substantially throughout the surface and body thereof on the treated side (as noted avocet, as well, the swelling and casting of electrolyte formulations on both side of such a base material is potentially preferred) in order to ensure such electrolyte deposition on such a flexible substrate. Thus, any hydrophilic material with swellable fibers (or surface components) may thus be utilized in this manner, as well.

An energy storage device may be one of any type of battery (rechargeable preferably), capacitor, and the like. Such an energy storage device may comprise, without limitation, components introduced and sealed within a housing, which itself includes tabs or other conductive components on the outer surface thereof for electrical charge transfer. Such components introduced and sealed within a housing generally include, again, without limitation, an anode, an anode current collector, a cathode, a cathode current collector, and the disclosed thin, porous semisolid electrolyte article, which may be provided as a separator and simultaneously as an electrolyte source as well. Disclosed herein is thus a thin porous semisolid electrolyte membrane (article) that exhibits high ionic conductivity and thermal and electrochemical stability within an energy storage device and imparts enhanced cycling performance as well as suitable elasticity and flexibility through appropriate mechanical strength. Such an overall device thus may be easily manufactured as well, with facilitated processing from initial base material treatments through internal battery component arrangement and disposition, as well as reduced if not eliminated need for liquid electrolytes.

### BRIEF DESCRIPTION OF THE DRAWINGS

FIG. 1A shows a prior art scanning electron microscope view of a cellulose battery separator.

FIG. 1B shows a prior art scanning electron microscope view of a cellulose battery separator subsequent to utilization within a liquid electrolyte system.

FIG. 2A shows a cellulose base material under a scanning electron microscope.

FIG. 2B shows a scanning electron microscope view of a finished semisolid membrane the cellulose base material of FIG. 2A subsequent to application of two distinct layers of electrolyte cast thereon and prior to utilization within a battery.

FIG. 3 provides a diagram of the two-layer electrolyte casting of FIG. 2B.

FIG. 4 shows a diagram of the placement of an embodiment of the membrane of FIGS. 2B and 3 between an anode and a cathode within a battery.

FIG. 5 shows a comparison of galvanostatic cycling voltage measurements between the utilization of the membrane of FIGS. 2B and 3 and a standard liquid electrolyte battery.

FIG. 6 shows formation charge/discharge curves for a battery utilizing a membrane embodiment of this disclosure.

FIG. 7A shows charge/discharge curves for the embodiment tested in FIG. 6 after 60 cycles.

FIG. 7B shows retention rates for the embodiment tested in FIG. 6 after 60 cycles.

### DETAILED DESCRIPTION OF THE PREFERRED EMBODIMENTS AND DRAWINGS

The following descriptions and examples are merely representations of potential embodiments of the present disclosure. The scope of such a disclosure and the breadth thereof in terms of claims following below would be well understood by the ordinarily skilled artisan within this area.

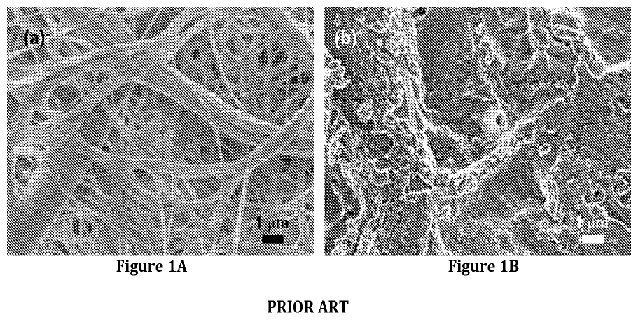

FIG. 1A shows scanning electron micrograph of neat cellulose fiber (prior art)(all such SEM micrographs are provided herein at a 1 micron magnification level). It can be observed that there are many pores in the microstructure of the cellulose fiber. When the neat cellulose fiber membrane was used as a separator, most of the pores are blocked by the decomposed electrolyte and lithium-ion during the cycling because cellulose membrane uptakes electrolyte and is swollen, FIG. 1B. This blockage inhibits lithium-ion movements between cathode and anode, and ultimately lead to failure of lithium-ion batteries.

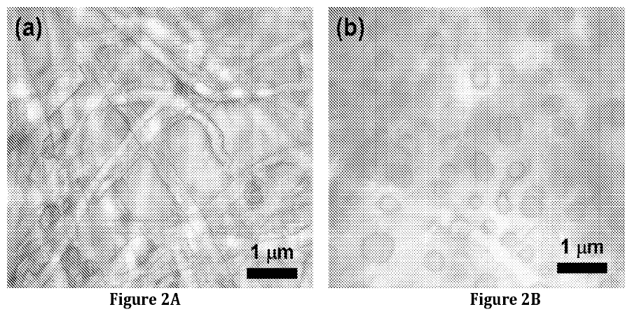

FIG. 2A provides an initial optical micrograph of neat cellulose fiber (much like that shown above), but with focus on pores therein. A significant amount thereof as seen. The fabrication method disclosed herein provide initial swelling (as described below in the membrane production examples). FIG. 2B thus shows the same view, basically, subsequent to the first and second coatings of SEM solution (polymer electrolyte solution). As can be seen, most pores are filled with polymer electrolytes thereafter. Such cellulose or lignin or other type of hydrophilic membrane that exhibits such swellability for pore increase and electrolyte deposition in this manner and in relation to this fabrication method, may be treated in this manner with any number of effective electrolytes, including, combination(s) between rotating molecules namely, plastic crystals such as cyano derivatives included mono or dicyano molecules and polymers. Such polymer formulations may comprise synthetic polymers like polyethylene oxide or glycol, polymethyl methacrylate, polyacrylonitrile, polyvinyl alcohol, polyvinylidene fluoride, polyvinylidene difluoride, polytetrafluoroethylene, and many different biopolymers to generate the same result. Such a method as disclosed herein on such a hydrophilic base material generates a highly uniform and mechanically robust enough thin semisolid electrolyte membrane using a well-interweaved cellulose fiber or membrane. A highly viscous polymer or co-polymer electrolyte solution included cyano molecule(s) will apply on the cellulose or any hydrophilic substrates. The cellulose membrane/fiber will be swollen after the first polymer electrolyte coating then the second coating will be followed and fill into the micro-pores or any voids to build a dense polymer electrolyte membrane as shown in the scanning electron microscope view in FIG. 2B, as noted above.

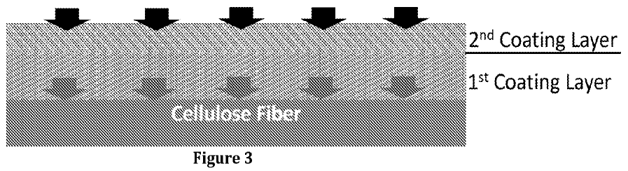

FIG. 3 provides a diagram drawing of such a multi-layer electrolyte deposition result on a hydrophilic membrane. The proposed concept in this diagram shows the first SEM coating on the cellulose fiber membrane fills the pores. The second coating forms a dense SEM membrane on top of the initial layer (as well as fills any remaining pores within the swollen pores of the base hydrophilic membrane).

The essential advantage of this disclosed semi-solid electrolyte membrane (semi-SEM) concept is the facilitated manufacturing compared with free-standing solid-state electrolyte membranes particularly due to an increase of mechanical integrity. In addition, such semi-SEMs exhibit promising and effective electrochemical stability, too. Furthermore, the gel-type morphology thereof such disclosed semi-SEMs provide superior flexibility, thereby ensuring a tight contact between electrodes and such disclosed semi-SEM surfaces that can significantly reduce interfacial resistance. Finally, the disclosed semi-SEMs utilize relatively inexpensive and abundant materials, such as cellulose fibers and films, as non-limiting examples. As such, this disclosed high-energy semi-solid electrolyte concept is comparable to if not better than standard oxide and/or sulfide-based solid-state electrolytes.

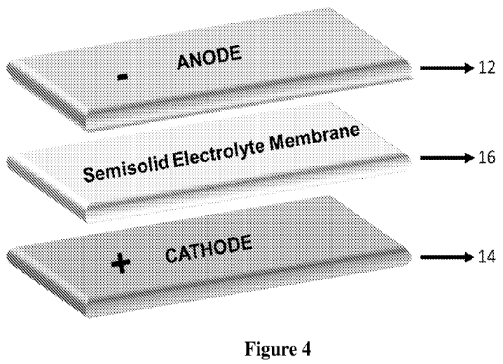

Such a finished flexible electrolyte membrane disclosed herein may be utilized as a battery separator (as shown in FIG. 4, for example). An anode 12, a cathode 14, and the disclosed flexible electrolyte membrane battery separator 16 are sandwiched together to form the basis of a battery (here in stacked relation to one another). Other energy storage device structures may be provided utilizing such a flexible electrolyte battery separator component, including jelly-roll, prismatic, stacked, and other common arrangements.

### Membrane Production

Cellulose fiber membrane (Ti-30) was supplied from Dream Weaver International (Greer, South Carolina). Ethylene carbonate (EC), polyacrylonitrile (PAN), polyethylene oxide (PEO), lithium hexafluorophosphate (LiPF6), and glutaronitrile (GN) were provided by Sigma Aldrich (St. Louis, MO).

9.4 g of EC was first melted at 70° C. with stirring (60 rpm). Subsequently, 0.8 g of PAN was introduced to form a sufficient solution amount. This mixture was then stirred using a stir plate (60 rpm) at 70° C. for 2 hours. 0.24 g of PEO was dissolved in the solution until fully dissolved. About 0.5 M of lithium salt, such as Lithium bis-(trifluoromethanesulfonyl)imide (LiTFSI), Lithium hexafluoro-arsenate (LiAsF₆), and LiPF₆, was added into the solution followed by stirring with 60 rpm at 80° C. for 90 minutes. In turn, 19.3 wt. % of 1,3-Dicyanopropane was added and the solution was stirred at 70° C. for 1 hour. The final solution showed a yellowish color.

Pre-dried Ti-30 sheets were cut to make 8×5 cm² rectangles. The cut Ti-30 rectangles were gently laid down on glass surfaces. By using Dr. Blade at a 30 mm gap, the solid electrolyte membrane (SEM) solution (from the paragraph above) was casted on Ti-30 surface. Three castings were performed with the first and second castings applied on the front (top) sides of the rectangle membranes. The first and second castings utilized 2 and 1 ml of the solid electrolyte membrane (SEM) solution, respectively. The final casting was performed on the back (bottom) sides of the Ti-30 rectangle membranes with 2 ml of SEM solutions. Between each casting process, the subject membranes were dried at 60° C. in a vacuum chamber for 5 minutes. After the completion of the casting processes, the SEM was still wet. The SEM was then further dried within an inert gas (nitrogen) atmosphere (in a glove box). The final SEM then exhibited a slightly wet surface for proper applications (castings) to take effect at the outer surface to fill the entirety of any pores remaining on the base material, initial electrolyte deposition composite. Such process steps were thus undertaken to allow for a continuous status check of the SEM layers (and all steps undertaken, as above, within an inert gas atmosphere in a glove box). Such fabricated semisolid thin, porous electrolyte articles were then collected and introduced within battery formations and device.

The observed uptake behavior of cellulose fibers (the pore filling hydrophilic rotating molecules delivering lithium-ions) thus provides a significantly different, if not improved, electrolyte membrane. To verify this hypothesis, SEM solution was casted on the cellulose Ti-30 membrane. The first coating of SEM solution on the cellulose fiber membrane fills the pores and forms the distribution of rotating molecules (plastic crystals) within the pores. The wetting of cellulose molecules and the insertion of SEM solution in the pores induces the swelling of the cellulose material. The second coating of SEM solution on the cellulose/electrolyte composite initially formed then covers the first layer and fills the remaining pores to form a dense SEM. The rotating molecules filling the pores effectively deliver the lithium-ions from cathode to anode and vice versa. The cellulose fiber network provides mechanical stability and processability while the rotating molecule insertion in the pores of cellulose fiber forms ionic pathway between cathode and anode. The observed ionic conductivity levels of the disclosed semi-SEMs are about 10⁻⁴ S/cm at room temperature whereas free-standing (standard) SEMs exhibit about 10⁻³ S/cm at room temperature.

### Battery Production

To make symmetric cells, two lithium metal (100 mm thickness) electrodes were punched to 16 mm diameters. The punched electrodes were attached on stainless steel (SUS) spacers. The SEM (from above) was sandwiched between the lithium metal. The order of symmetric coin cell assembly was: bottom case, lithium metal electrode on SUS, SEM, lithium metal electrode on SUS, wave spring, and top case. In the case of conventional lithium-ion battery cell, bottom case, cathode laminated on aluminum foil, SEM, lithium metal anode laminated on copper foil, 1 mm spacer, wave spring, and top case.

### Experimental Testing and Results

We performed symmetric cell experiments to evaluate whether the developed solid electrolyte membrane (SEM) electrochemically works correctly. The positive and negative electrodes were lithium metal foil with 100 mm thickness placed on SUS. Electrochemical stripping/plating test of the Li—Li symmetric cell has been conducted at following order.
1. 0.1 mA/cm² for each 30 min during stripping/plating on 1^{st} cycle
2. 0.25 mA/cm² for 30 min on 2^{nd} cycle
3. 0.5 mA/cm² for 30 min on 3^{rd} cycle
4. 1 mA/cm² for 1 hour (Aerial Capacity: 1 mAh/cm²) from 4^{th} cycle to the end of test.
   The life of the Li—Li symmetric cells was determined as the time for the overpotential to increase to 0.2 V.

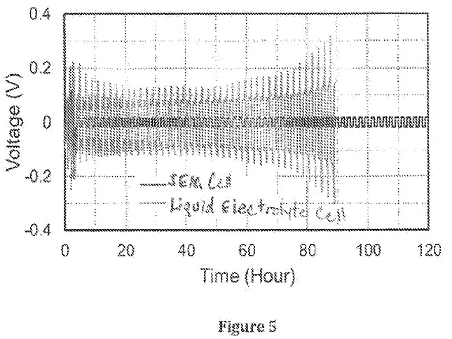

FIG. 5 shows galvanostatic cycling voltage profile for Li—Li symmetric cells cycled at 1 mAh/cm² (1 mA/cm² at 1 hr for each stripping and plating) with the SEM. Another Li—Li symmetric cell with conventional liquid electrolyte and polymer separator experienced the same basic experimental conditions to demonstrate the performance of the SEM. Surprisingly, no significant overpotential was observed within or by the SEM cell for 120 hours. In contrast, a conventional Li—Li symmetric cell showed relatively unstable charging and discharging behavior. Furthermore, the overpotential of the conventional cell exceeded 0.2 V around 80 hours. The life span of the disclosed SEM cell was more than 30% improved compared to such a conventional cell. Thus, it was hypothesized that the developed disclosed SEM effectively prohibited the formation of dendrites within the battery cell and thus reduced the propensity of corresponding degradation of lithium metal.

The formation process (the first lithiation-dilithiation cycle) for lithium-ion batteries (LIBs) creates a solid electrolyte interphase (SEI) on the anode surface. The uniform and stable SEI layers prevent unwanted irreversible electrolyte and lithium consumption, which prolongs the lifetime of LIBs. Thus, to ensure a stable and uniform SEI layer formation, there was further undertaken the application of sufficiently slow charging and discharging processes, 0.1 C. Such a 0.1 C current hypothetically requires 10 hours to reach full charge or discharge of the target battery. The State of Charge (SOC) section was from 0 to 100% without skipping low and high voltage bands. Thus, the used voltage range was determined to be from 3.0˜4.3 V. The cathode was made from commercially available Nickel-Rich Nickel-Manganese-Cobalt powder: molar ratio of these elements is Nickel:Manganese:Cobalt was 8:1:1 (NMC811). NMC811 cathode, the developed SEM, and lithium metal anode were stacked in the coin cell structure.

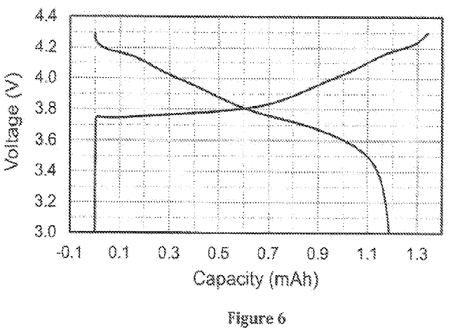

FIG. 6 shows the formation cycle of the cell containing the developed SEM. The formation curves show that charging curves reach 4.3 V at the end of the charging process. Furthermore, Coulombic efficiency (CE) of the cell is high enough, 88.5%. Thus, such a result appeared to ensure that SEI layers were sufficiently formed on anode surface.

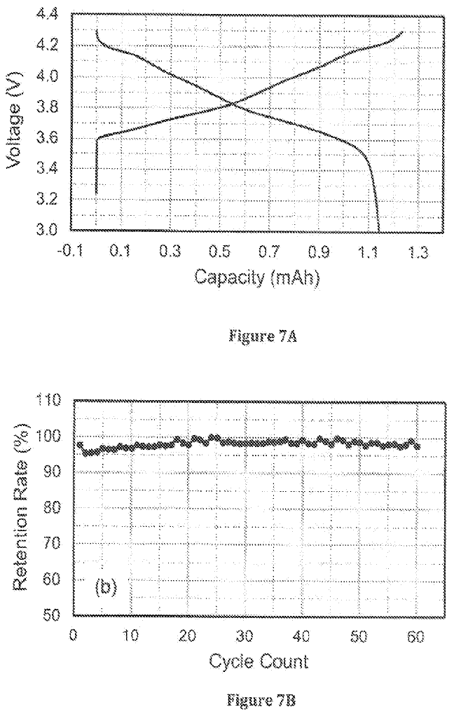

After the formation process, there was then performed a cycling test to monitor the formed cell performances and degradation behaviors. The probable causes of degradation within such battery devices are lithium-ion consumption, a reduction of conductivity due to irregular thickening of SEI layer, and formation of lithium metal dendrites which would lead to eventually dead lithium metal anodes. Such degradation levels may be quantified by monitoring Capacity Retention Rate (CRR). Unexpectedly, the CRR of the disclosed thin-porous flexible electrolyte membrane-containing cells were measured to be in excess of 90% up to 120 hours with the charging and discharging currents of 0.3 C. FIGS. 7A and 7B show the charging and discharging trends of 60th cycle and retention rate, respectively. These results indicate no severe degradation occurred within the SEM structure, at the interface between anode and the SEM surfaces, and lithium metal anode structure. The developed SEM effectively delivers lithium-ion from cathode to anode and anode to cathode without noticeable loss of lithium-ion. Furthermore, high CRR after 120 hours led to speculation that no significant structural alterations of lithium metal anode have occurred. Therefore, unwanted dendrite formation was also efficiently limited by the SEM. Table 1 compares the CEs of the first and second cells to support the speculations above.

TABLE 1
Charging and Discharging Capacity and Efficiency
of the Formation and 60^{th} cycles

| Formation Cycle | | | 60^{th} Cycle | | |
|---|---|---|---|---|---|
| Charging | Discharging | Effi- | Charging | Discharging | Effi- |
| Capacity | Capacity | ciency | Capacity | Capacity | ciency |
| (mAh) | (mAh) | (%) | (mAh) | (mAh) | (%) |
| 229 | 203 | 88.5 | 211 | 195 | 92.4 |

With these examples, experimental test results, and descriptions, there is provided a significantly improved solid state polymer electrolyte membrane for utilization with and within battery devices. The combination of cyano molecules, lithium salts, plasticizer(s), a base hydrophilic polymer material (that exhibits swelling in the presence of electrolyte polymer formulations as described herein), and a nano- or micro-filler, has been found to accord excellent performance in every needed criterium. A robust, mechanically strong and effective electrolyte membrane is thus provided that accords unexpected results within energy storage devices and allows for utilization of a flexible battery separator in this manner with effective ion transfers therethrough.

It should be understood that various modifications within the scope of this invention can be made by one of ordinary skill in the art without departing from the spirit thereof. It is therefore wished that this invention be defined by the scope of the appended claims as broadly as the prior art will permit, and in view of the specification if need be.

What is claimed is:

1. A semisolid electrolyte membrane exhibiting a tensile strength of from 1 to 50 MPa, wherein said membrane comprises a swollen porous base material having a top side and a bottom side and selected from hydrophilic fibers, hydrophilic films, and any combinations thereof, wherein said swollen porous base material comprises at least two layers of electrolyte deposited thereon at least one of said top and bottom side thereof, wherein a first layer of said electrolyte deposition resides within at least some of the pores as well as on the surface of said swollen porous base material and wherein a second layer of said electrolyte deposition resides on top of said first layer of said electrolyte deposition, and wherein said semisolid electrolyte membrane exhibits ionic conductivity of from 10⁻⁴ S/cm to 10⁻³ S/cm.

2. The semisolid electrolyte membrane of claim 1 further comprising at least two electrolyte deposition layers, said at least two electrolyte deposition layers including rotating molecules to permit ion transfer through said membrane.

3. The semisolid electrolyte membrane of claim 2 wherein said rotating molecules are selected from the group consisting of cyano molecules.

4. The semisolid electrolyte membrane of claim 3 wherein said cyano molecules are selected from the group consisting of mono- and di-cyano molecules.

5. The semisolid electrolyte membrane of claim 4 wherein said mono- and di-cyano molecules are selected from the group consisting of 1,4-Dicyanobutane, 1,2-Dicyanoethane, 1,3-Dicyanopropane, 1,5-Dicyanopentane, 1,6-Dicyanohexane, trans-1,4-Dicyano-2-butene, trans-1,2-Dicyanoethylene, α-methyl-valerodinitrile, percyanoethylene, tetracyanoethylene, 2,5-Cyclohexadiene-1,4-diylidene and any like cyano-derivatives thereof.

6. The semisolid electrolyte membrane of claim 1 wherein said porous hydrophilic polymer material is selected from the group consisting of cellulose, semi-cellulose, hemi-cellulose, and lignin.

7. The semisolid electrolyte membrane of claim 6 wherein said porous hydrophilic polymer material is cellulose.

8. The semisolid electrolyte membrane of claim 6 further comprising at least two electrolyte deposition layers, said at least two electrolyte deposition layers including rotating molecules to permit ion transfer through said membrane.

9. The semisolid electrolyte membrane of claim 8 wherein said rotating molecules are selected from the group consisting of cyano molecules.

10. The semisolid electrolyte membrane of claim 9 wherein said cyano molecules are selected from the group consisting of mono- and di-cyano molecules.

11. The semisolid electrolyte membrane of claim 10 wherein said mono- and di-cyano molecules are selected from the group consisting of 1,4-Dicyanobutane, 1,2-Dicyanoethane, 1,3-Dicyanopropane, 1,5-Dicyanopetane, 1,6-Dicyanohexane, trans-1,4-Dicyano-2-butene, trans-1,2-Dicyanoethylene, α-methyl-valerodinitrile, percyanoethylene, tetracyanoethylene, 2,5-Cyclohexadiene-1,4-diylidene and any like cyano-derivatives thereof.

12. The thin porous semisolid electrolyte membrane of claim 7 further comprising at least two electrolyte deposition layers, said at least two electrolyte deposition layers including rotating molecules to permit ion transfer through said membrane.

13. The semisolid electrolyte membrane of claim 12 wherein said rotating molecules are selected from the group consisting of cyano molecules.

14. The semisolid electrolyte membrane of claim 13 wherein said cyano molecules are selected from the group consisting of mono- and di-cyano molecules.

15. The semisolid electrolyte membrane of claim 14 wherein said mono- and di-cyano molecules are selected from the group consisting of 1,4-Dicyanobutane, 1,2-Dicyanoethane, 1,3-Dicyanopropane, 1,5-Dicyanopetane, 1,6-Dicyanohexane, trans-1,4-Dicyano-2-butene, trans-1,2-Dicyanoethylene, α-methyl-valerodinitrile, percyanoethylene, tetracyanoethylene, 2,5-Cyclohexadiene-1,4-diylidene and any like cyano-derivatives thereof.

16. A rechargeable energy storage device comprising the semisolid electrolyte membrane of claim 1, wherein said energy storage device comprises at least one anode and one cathode, and wherein said semisolid electrolyte membrane is present between said at least one anode and said at least one cathode.

17. A rechargeable energy storage device comprising the semisolid electrolyte membrane of claim 5, wherein said energy storage device comprises at least one anode and one cathode, and wherein said semisolid electrolyte membrane is present between said at least one anode and said at least one cathode.

18. A rechargeable energy storage device comprising the semisolid electrolyte membrane of claim 7, wherein said energy storage device comprises at least one anode and one cathode, and wherein said semisolid electrolyte membrane is present between said at least one anode and said at least one cathode.

19. A rechargeable energy storage device comprising the semisolid electrolyte membrane of claim 11, wherein said energy storage device comprises at least one anode and one cathode, and wherein said semisolid electrolyte membrane is present between said at least one anode and said at least one cathode.

20. A rechargeable energy storage device comprising the semisolid electrolyte membrane of claim 15, wherein said energy storage device comprises at least one anode and one cathode, and wherein said semisolid electrolyte membrane is present between said at least one anode and said at least one cathode.

21. A semisolid electrolyte membrane exhibiting a tensile strength of from 1 to 50 MPa, wherein said membrane comprises a swollen porous base material having a top side and a bottom side and selected from hydrophilic fibers, hydrophilic films, and any combinations thereof, wherein said swollen porous base material comprises a dense electrolyte deposition thereon at least one of said top and bottom side thereof, wherein said dense electrolyte deposition resides within the pores of and on the surface of said swollen porous base material, and wherein said semisolid electrolyte membrane exhibits ionic conductivity of from 10⁻⁴ S/cm to 10⁻³ S/cm.
